(19) United States
(12) Patent Application Publication
(10) Pub. No.: US 2010/0038823 A1
(43) Pub. Date: Feb. 18, 2010

(54) COMPRESSION-MOULDING METHODS

(75) Inventors: Matteo Camerani, Russi (IT); Fiorenzo Parrinello, Medicina (IT)

Correspondence Address: Pearne & Gordon LLP, 1801 East 9th Street, Suite 1200, Cleveland, OH, 44114-3108, US

(73) Assignee: Sacmi Cooperativa Meccanici Imola Societa' Coopera, Imola (Bologna) (IT)

(21) Appl. No.: 12/440,434

(22) PCT Filed: Sep. 3, 2007
(86) PCT No.: PCT/IB07/02531

§ 371 Date: Mar. 6, 2009

(30) Foreign Application Priority Data
Sep. 6, 2006 (IT) MO2006A000269

(51) Int. Cl. B29C 43/54

(52) U.S. Cl. 264/319

(57) ABSTRACT

A method for compression-moulding a dose of plastics in a mould having a first forming arrangement and a second forming arrangement comprises the steps of:
moving the first forming arrangement towards the second forming arrangement at a speed that is variable according to a preset profile, the preset profile being so chosen as to apply reduced stress to the plastics, in order to obtain an object from the dose;
maintaining the object in the mould while applying variable pressure to the plastics according to a preset further profile, the preset further profile being so chosen as to reduce the stress in the plastics;
extracting the object from the mould.

The invention relates to methods for compression-moulding a dose of plastics so as to obtain an object, for example a preform, a cap, a washer or any other product.

The preform obtained with the methods according to the invention can be subjected to stretch-blow-moulding to produce a container, in particular a bottle. The cap obtained with the methods according to the invention can on the other hand be used to close known containers, such as bottles or receptacles of another type.

Apparatuses are known for compression-moulding doses of plastics, comprising a plurality of moulds each one of which is provided with a punch that reproduces the internal shape of the object to be moulded and with a die that reproduces the external shape thereof. The die is fixed to a stem of a hydraulic actuator supplied with a driving fluid, for example oil, so as to be movable with respect to the punch. Alternatively, the die can be moved by an electric system or by another type of driving device.

Initially, the mould is in an open position in which the die is far from the punch in such a way that a dose of plastics can be deposited in the die and, simultaneously, the object that has just been formed can be removed from the punch.

At this point, the actuator moves the die towards the punch and the dose contained in the die starts to interact with the punch to be shaped according to the desired geometry. The dose is completely shaped when the mould reaches a closed position, in which between the punch and the die a closed forming chamber is defined having a shape substantially corresponding to that of the object that it is desired to obtain.

After the dose has been completely shaped and has assumed the shape of the desired object, the mould is maintained in the closed position and a defined pressure is applied to the plastics.

A cooling fluid circulating in a plurality of conduits obtained in both the die and in the punch cools the object that has just been formed so that the shape thereof stabilises.

Subsequently, the actuator moves the die away from the punch until it again reaches the open position, so as to extract the object from the mould.

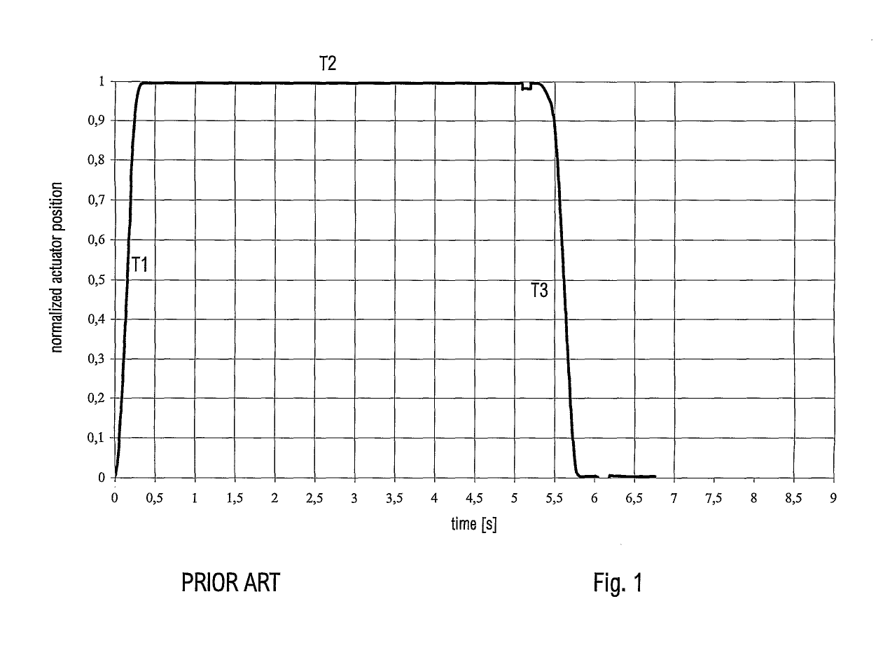

FIG. 1 shows how the position of the stem of the hydraulic actuator that moves the die varies in function of time, in the methods according to the prior art. In FIG. 1, a first portion T1 is identifiable approximately corresponding to a straight line with a high gradient, a second substantially horizontal portion T2 and a third portion T3 that also has the appearance of a straight line with a high gradient. The first portion T1 corresponds to the step during which the die is moved rapidly to the punch until it reaches the closed position, which is maintained for a preset period, shown by the second portion T2. Subsequently, as shown by the third portion T3, the die is moved quickly away from the punch until it reaches the open position.

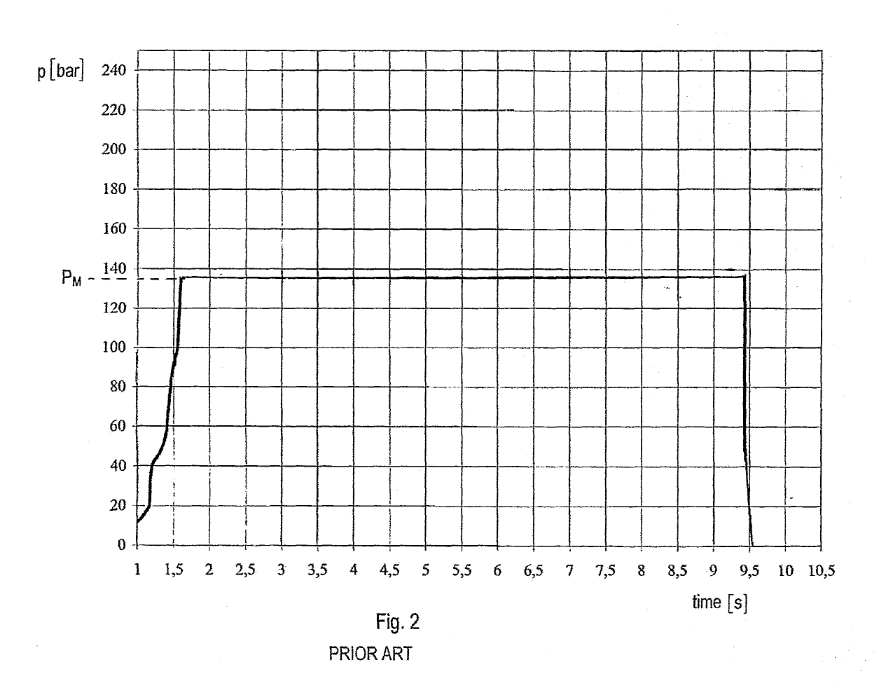

FIG. 2 shows how the pressure that is applied to the plastics varies in function of the time in the methods according to the prior art. It should be noted how, whilst the mould closes, the aforesaid pressure increases gradually until it reaches a maximum value indicated by PM when the closed position is reached.

Whilst the preform is maintained inside the mould arranged in a closed position, the pressure applied to the plastics is constant and equal to p_{M}. Lastly, when the extraction step starts, the pressure applied to the plastics decreases rapidly until it is reduced to zero.

A drawback of the known methods is that in plastics that are shaped in a technologically poorly controlled manner during moulding great cutting stress and pressure are generated and distributed in a non-uniform manner that may produce significant tension in the moulded object, from which many drawbacks arise.

In fact, during cooling the non-uniform pressure causes shrinking that varies from one point to another of the object, with the consequence that the moulded object may even be visibly deformed.

Owing to the great pressure and forces the plastics, whilst they fill the forming chamber, may also suffer overheating phenomena (so-called “stress over-heating”), that detract from the properties of the moulded object and increase the cycle time.

Further, the great stress may make possible thin zones of the moulded object fragile.

Also, if the moulded object is a preform to be subjected to successive stretch-blow-moulding operations for obtaining a bottle, owing to the great tension in the preform, visible defects may form on the bottle, for example scoring. The bottle may further have low mechanical performance and in the worst cases may even break whilst it is being blown. Further, owing to the great tension generated when the plastics are formed, in some points the molecules of plastics may become orientated so as to form opaque crystalline zones that are fragile and easily visible if the moulded object is transparent, as often occurs for preforms. This phenomenon is known as “stress whitening”.

A further drawback of known methods is that these methods require significant energy consumption to maintain great force applied for a long period to the plastics, when the mould is in a closed position.

Further, in known methods difficulties are sometimes encountered in extracting the finished objects from the mould. The plastics, as they cool, shrink and the object tightens around the punch. In order to remove the object from the punch, great force is therefore necessary that requires great energy and may damage the object.

EP 0458577 discloses a method of manufacturing a resin-sealed type semiconductor device, comprising the steps of heat sealing the resin whilst the resin is contacted with a cull portion of a mould part by means of a plunger fitted to another mould part during a predetermined period during which the plunger is stationary. The sealing resin is sufficiently heated to assume a low viscosity melted state. Thereafter, the melted resin is injected into a cavity where resin sealing is performed.

US 2003/0230821 discloses a compression moulding method and mould clamping apparatus that may be suitable for use in injection compression moulding, injection press moulding, and pressurized press moulding of synthetic resin material and other moulding compounds.

US 2004/0096539 discloses an apparatus for moulding an optical lens from a molten thermoplastic resin material using an injection moulding machine.

U.S. Pat. No. 3,692,456 discloses an apparatus for converting molten thermoplastic in cup-like articles, which involves the use of a mould comprising male and female dies having opposed surfaces which, when the mould is fully closed, define a closed cavity having the shape of a cup. An object of the invention is to improve the methods for producing objects by compression-moulding doses of plastics, in particular by improving filling of the moulds used in these methods.

A further object is to reduce the internal tension in compression-moulded objects.

A still further object is to decrease cycle time and reduce the energy consumption required for compression-moulding doses of plastics.

Another object is to improve the extraction from the moulds of compression-moulded objects.

In a first aspect of the invention, there is provided a method for compression-moulding a dose of plastics in a mould having a first forming arrangement and a second forming arrangement, comprising the steps of:
moving said first forming arrangement towards said second forming arrangement at a speed that is variable according to a preset profile, said profile being so chosen as to apply reduced stress to said plastics, in order to obtain an object from said dose;
maintaining said object in said mould while applying to said plastics pressure that is variable according to a preset further profile, said preset further profile being so chosen as to reduce the stress in said plastics;
extracting said object from said mould. Owing to this aspect of the invention, it is possible to improve the methods for compression-moulding doses of plastics. In fact, the speed of the first forming arrangement and the pressure applied to the plastics can be set in such a way as to minimise the stress generated in the plastics.

By suitably selecting the speed profile of the first forming arrangement, and in particular by decreasing the speed of the first forming arrangement, when the latter is moved towards the second forming arrangement, the plastics are in fact stressed much less than they are by known methods. In the object that is about to be produced lower stress and pressure are thus generated.

This enables the quality of the moulded object to be significantly improved. In particular, the phenomena of “stress whitening” and “stress overheating” are substantially avoided and fragile zones in the finished object are unlikely.

Further, by suitably selecting the pressure profile applied to the plastics whilst the object is maintained inside the closed mould, and in particular by reducing this pressure, the plastics are able to relax before being completely cooled, which enables the tension in the finished object to be reduced further. As the plastics are less tensioned, the finished object undergoes more homogenous dimensional shrinkage, which makes it easier to extract the object from the mould.

Further, owing to the low tension in the moulded object, a relatively short time. is required for the shape of the moulded object to stabilise inside the closed mould. The object can thus be rapidly extracted from the mould, which enables cycle time to be reduced.

By decreasing the pressure applied to the plastics whilst the object is maintained within the mould it is also possible to reduce energy consumption with respect to known methods, because high pressure is applied to the object only for very few instants.

In a second aspect of the invention, there is provided a method comprising the steps of:
compression-moulding a dose of plastics in a forming chamber defined inside a mould, so as to obtain an object;
cooling said object in said forming chamber;
extracting said object from said forming chamber;

wherein during said cooling there is provided increasing the volume of said forming chamber to decrease stress in said plastics.

Owing to this aspect of the invention, it is possible to decrease the stress inside the plastics. By increasing the volume of the forming chamber whilst the object is cooled, i.e. in a moment in which the object has a relatively cold surface skin and a central core that is still hot and fluid, the plastics can in fact easily return to a less tensioned configuration, owing to a phenomenon known as “reverse flow back”.

In a third aspect of the invention, there is provided a method comprising the steps of:
compression-moulding a dose of plastics in a mould so as to obtain an object;
maintaining said object in said mould while applying pressure to said plastics;
extracting said object from said mould;

wherein, during said maintaining, said pressure is decreased according to a preset profile, said profile being so chosen as to reduce stress in said plastics.

By decreasing the pressure applied to the plastics whilst the formed object is kept inside the closed mould, it is possible to reduce cycle time and energy consumption with respect to known methods. Further, by reducing the applied pressure, the plastics are stressed less.

The invention can be better understood and implemented with reference to the attached drawings that illustrate some embodiments thereof by way of non-limiting example, in which:

FIG. 1 is a graph that shows schematically how the position of the actuator that moves the die varies in function of time in a method according to the prior art;

FIG. 2 is a graph that shows schematically how the pressure applied to the plastics varies in function of time in a method according to the prior art;

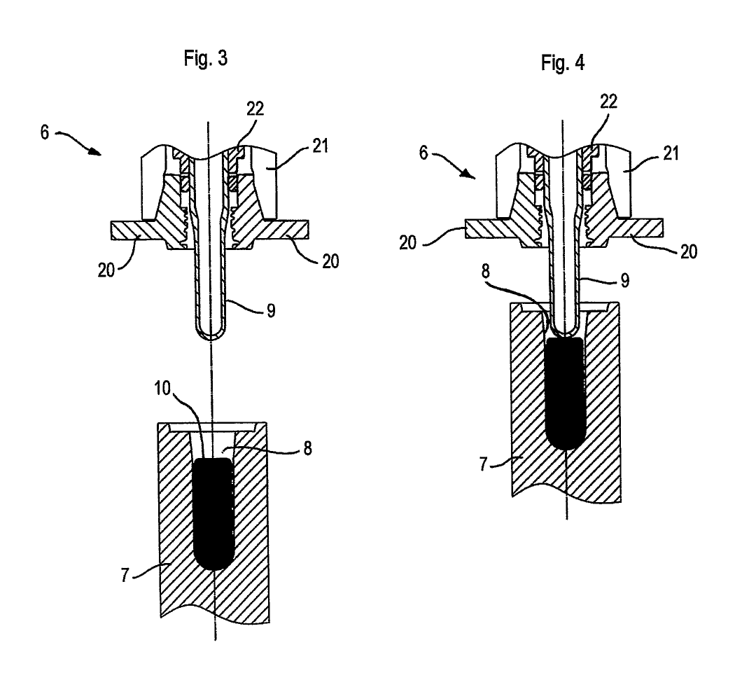

FIG. 3 is a partially sectioned schematic view that shows a mould for compression-moulding preforms, in an open position;

FIG. 4 is a view like the one in FIG. 3 showing the mould during a closing step;

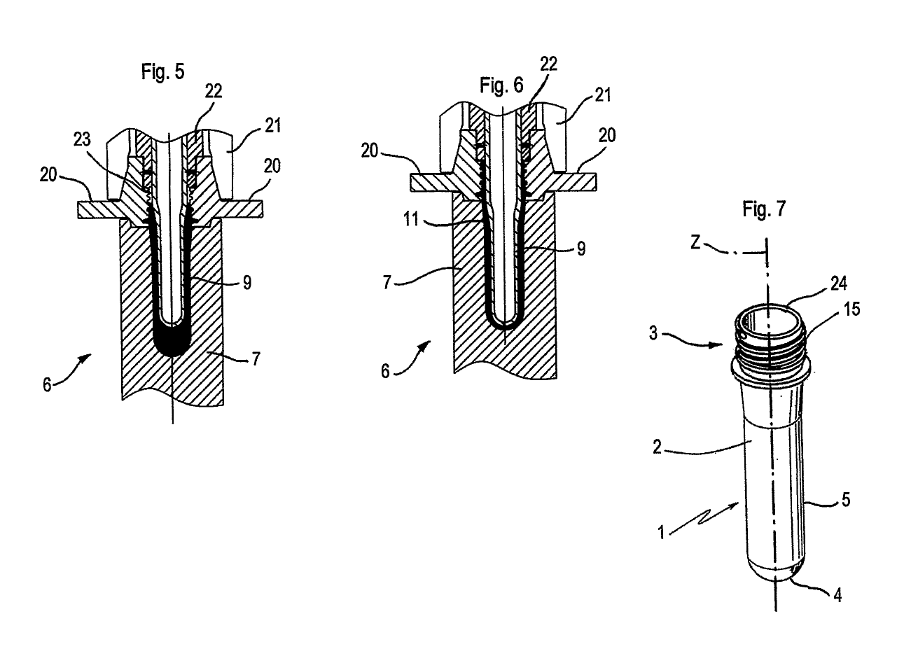

FIG. 5 is a view like the one in FIG. 3 showing the mould during the closing step in an instant after the one to which FIG. 4 refers;

FIG. 6 is a view like the one in FIG. 3 showing the already shaped preform inside the mould;

FIG. 7 is a perspective view of a preform that is obtainable with a method according to the invention;

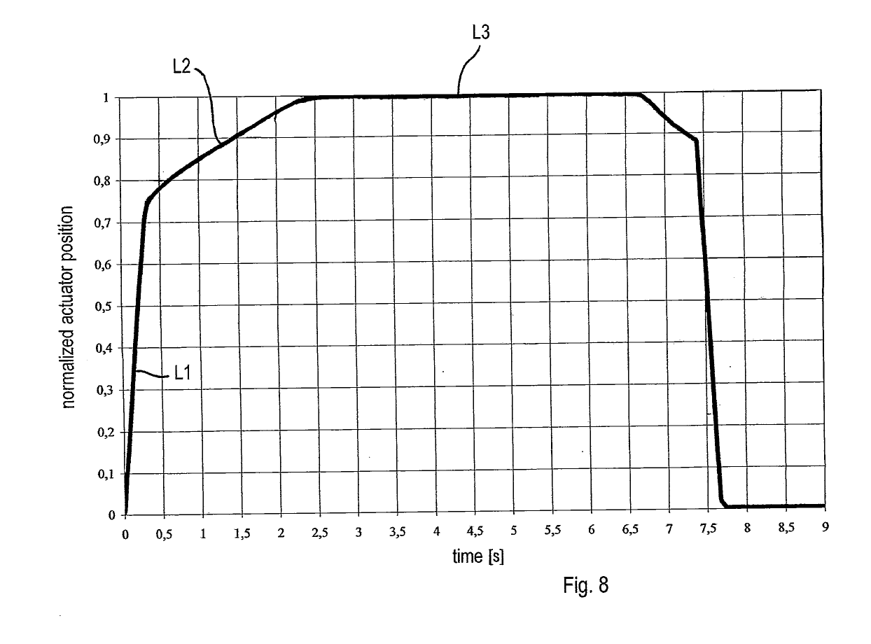

FIG. 8 is a graph that shows how the position of an actuator varies that moves a first forming arrangement of the mould in FIGS. 3 to 6;

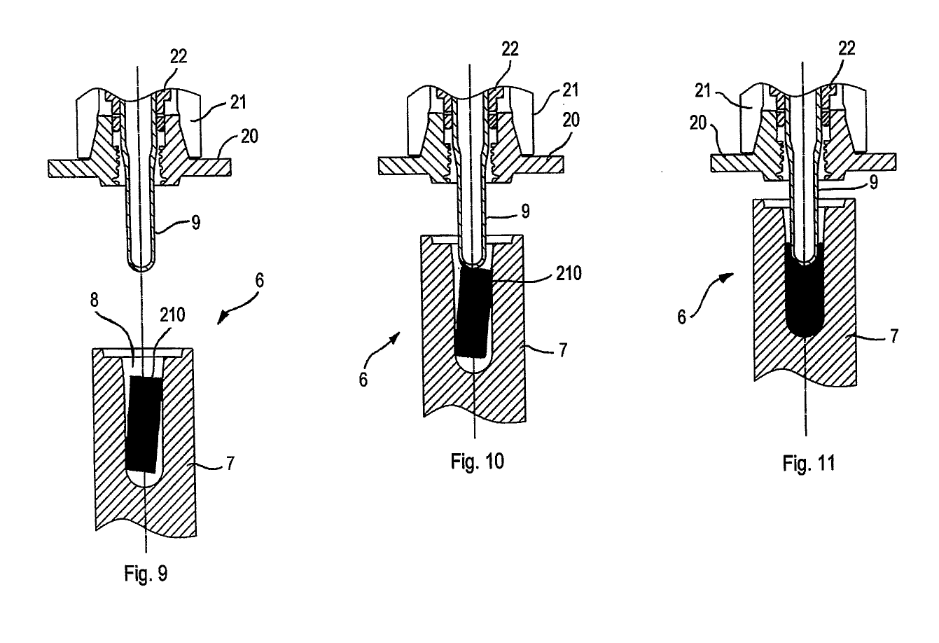

FIG. 9 is a view like the one in FIG. 3 showing a dose of plastics positioned badly inside the mould in the open position;

FIG. 10 is a view like the one in FIG. 9 showing the mould during the closing step, the dose still not being correctly positioned;

FIG. 11 is a view like the one in FIG. 9, that refers to an instant after the one in FIG. 10, in which the dose has been correctly positioned in the mould;

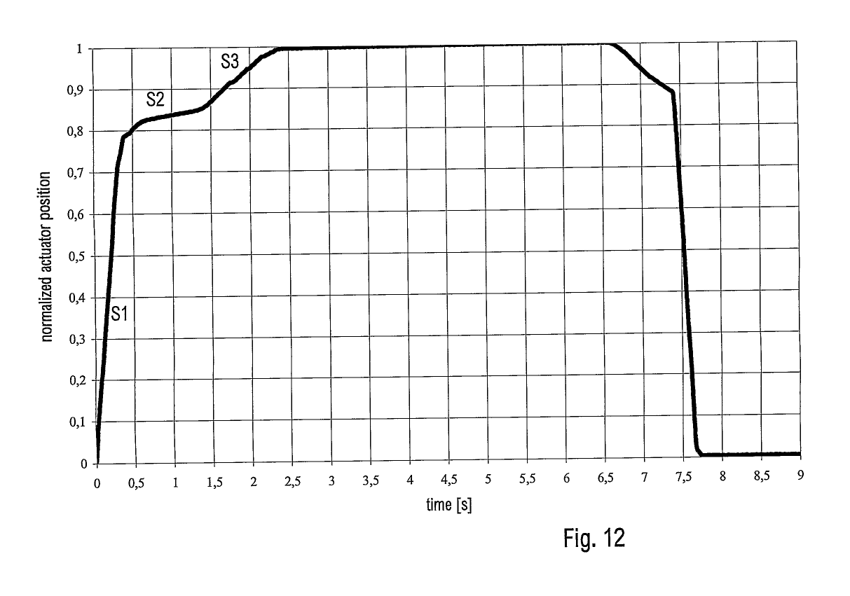

FIG. 12 is a graph that shows how the position of the actuator varies that moves the first forming arrangement of the mould in FIGS. 9 to 11;

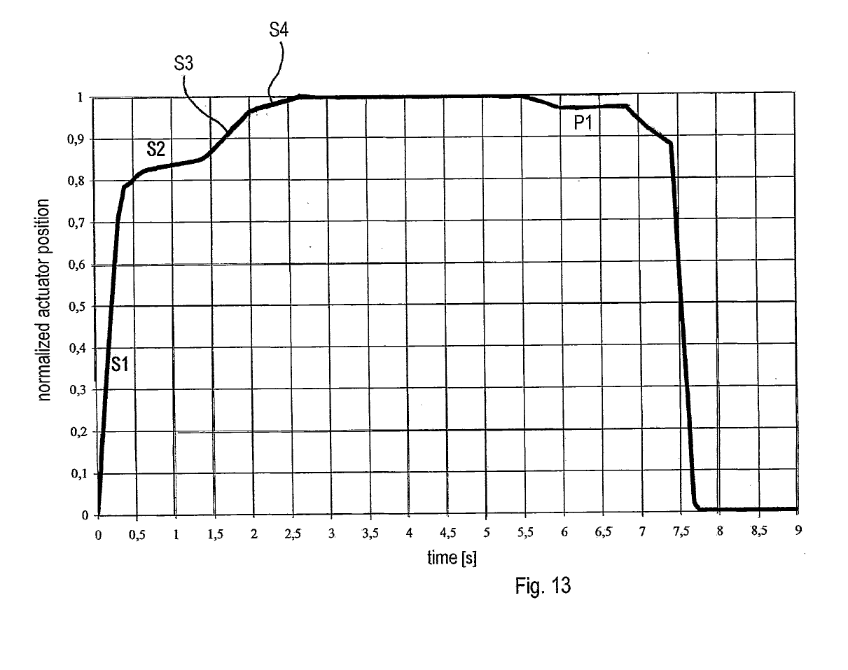

FIG. 13 is a graph like the one in FIG. 12, in which the position of the actuator varies according to an alternative law;

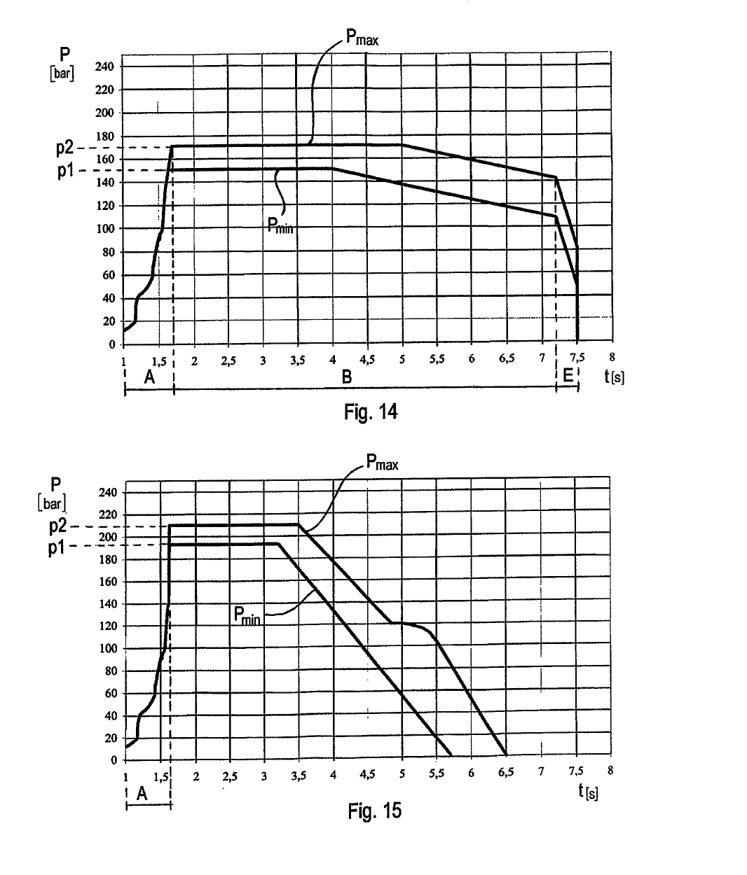

FIG. 14 is a graph showing how the pressure applied to the plastics shaped in a mould for compression-moulding preforms varies;

FIG. 15 is a graph like the one in FIG. 14, according to a first alternative embodiment;

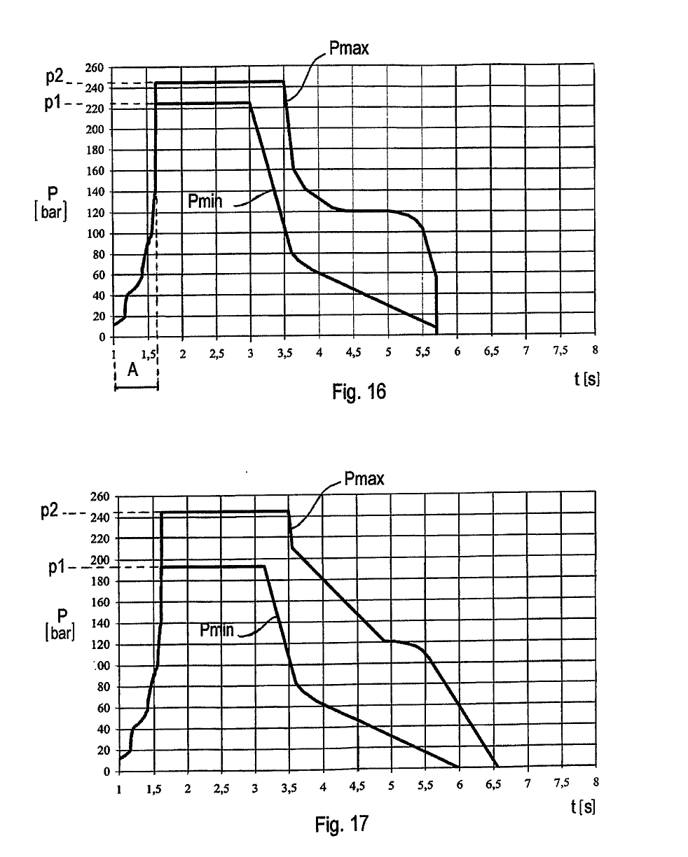

FIG. 16 is a graph like the one in FIG. 14, according to a second alternative embodiment;

FIG. 17 is a graph like the one in FIG. 14, according to a third alternative embodiment;

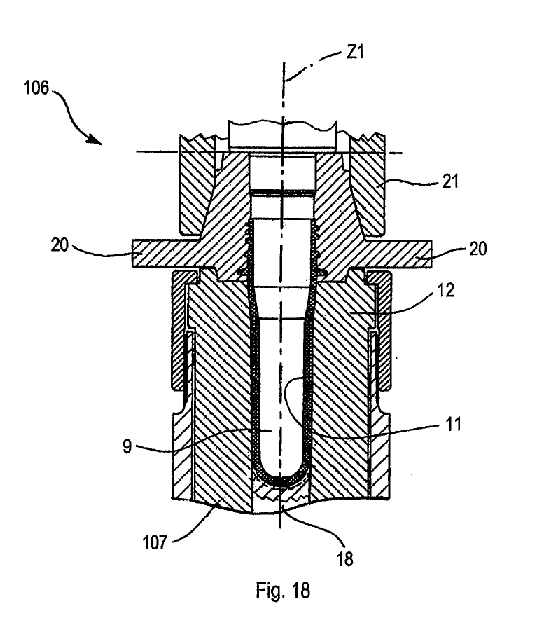

FIG. 18 is a partially sectioned view, like that in FIG. 6, showing a mould according to another embodiment.

FIG. 7 shows a preform 1 obtained with a method according to the invention and usable for producing a container, for example a bottle, through a stretch-blow-moulding process. The preform 1 is made of plastics, for example polyethyleneterephthalate (PET), polypropylene (PP), polyvinyl chloride (PVC), high density polyethylene (HDPE), polyethylene naphthalate (PEN), polystyrene (PS) or polylactic acid (PLA). The preform 1 comprises a hollow body 2 having a side wall 5 that extends around a longitudinal axis Z. The hollow body 2 is provided with an open end near which a mouth 3 is obtained that is provided with fixing elements comprising, for example, a threaded portion 15 suitable for engaging a cap for closing the container resulting from the preform 1. The mouth 3 is bounded by an annular edge zone 24. At an end opposite the mouth 3, the hollow body 2 is closed by an end wall 4 that extends transversely to the longitudinal axis Z.

FIGS. 3 to 6 show a mould 6 that can be used for compression-moulding the preform 1. The mould 6 comprises a first forming arrangement for shaping the preform 1 externally and a second forming arrangement for shaping this preform internally. The first forming arrangement comprises a die 7 provided with a cavity 8 in which the side wall 5 and the end wall 4 can be shaped externally. The first forming arrangement further comprises a pair of movable elements 20 for externally shaping the mouth 3. A sleeve 21 interacts with the movable elements 20 to maintain them next to one another.

The second forming arrangement comprises a punch 9 for shaping the preform 1 internally.

A tubular component 22, included in the first forming arrangement, surrounds the punch 9 and is movable with respect to the latter, so as to shape the annular edge zone 24 of the preform 1.

As shown in FIG. 3, the mould 6 is initially in an open position, in which the die 7 is spaced apart from the punch 9, so that it is possible to deposit in the cavity 8 a dose 10 of plastics in a pasty state, by means of a transferring device that is not shown.

Subsequently the die 7, by means of a driving device that is not shown, is moved towards the punch 9. The driving device may comprise a hydraulic actuator provided with a vertical stem having an upper end on which the die 7 is fitted. A driving fluid, for example oil, supplies the hydraulic actuator so as to move the stem and with it the die 7.

Whilst the die 7 moves towards the punch 9, the die 7 reaches a contact position shown in FIG. 4, in which an upper end of the dose 10 comes into contact with a lower end of the punch 9. After reaching the contact position, the die 7 continues to approach the punch 9, which starts to interact with the dose 10. The latter is thus gradually shaped until it takes on the shape of the preform 1.

Whilst the die 7 continues to be moved to the punch 9 from the contact position, a first intermediate position is reached that is not shown in which the die 7 abuts on the movable elements 20. From this moment, the die 7 moves to the punch 9 together with the movable elements 20 and the sleeve 21.

Subsequently, in a second intermediate position shown in FIG. 5, the movable elements 20 abut on the tubular component 22. A closed volume 23 is thus defined between the first forming arrangement and the second forming arrangement. The closed volume 23 is significantly greater than the volume of the preform 1 and is therefore not entirely occupied by the plastics.

After reaching the second intermediate position, the die 7 continues to move towards the punch 9, pushing the movable elements 20, the sleeve 21 and the tubular component 22 upwards. The closed volume 23 is thus gradually reduced until a final position is reached, shown in FIG. 6, in which between the first forming arrangement and the second forming arrangement a forming chamber 11 is defined having a shape substantially corresponding to that of the preform 1. The forming chamber 11 is substantially closed and is bounded by the die 7, by the movable elements 20, by the tubular component 22 and by the punch 9. When the die 7 has reached the final position, the preform 1 is already shaped, after which the preform 1 remains inside the mould 6 to be cooled so that the shape thereof stabilises. Subsequently, the mould 6 opens so that the preform 1 that has just been formed can be extracted and it is possible to start a new moulding cycle.

The die 7 is moved to the punch 9 at a speed that is variable according to a preset profile. This profile can, for example, be of the type shown schematically in the graph in FIG. 8, in which it is possible to see how the position of the stem of the actuator to which the die 7 is fixed varies during the moulding cycle of a preform 1 disclosed previously. In the time that elapses between the open position shown in FIG. 3 and the contact position shown in FIG. 4, the position of the actuator is shown by a first line L1, which is approximately rectilinear, having a high gradient. This means that the actuator moves the die 7 at a relatively high speed, for example equal to 1 m/s. During this time, the plastics constituting the dose 10 do not interact with the punch 9. No stress is thus generated in the plastics although the die 7 moves very quickly. It should be noted that moving the die 7 quickly enables the time to be reduced that is required for producing a preform 1.

During the time that elapses between the contact position shown in FIG. 4 and the final position shown in FIG. 6, the position of the actuator is shown by the second line L2, having a lesser gradient than the first line L1. This means that, whilst the plastics are shaped, the speed of the die 7 is decreased, i.e. the die 7 is moved to the punch 9 at a speed that is less than that at which the die 7 was driven before reaching the contact position. The speed of the die 7 whilst the plastics are shaped is selected in such a way as not to generate excessive stress in the plastics. For example, the speed of the die 7 during the step disclosed above may be equal to 0.2 m/s.

In the example shown in FIG. 8, the actuator uses approximately 75% of its stroke to bring the dose 10 contained in the die into contact with the punch 9. The plastics are shaped during the remaining 25%. The speed of the die 7 is thus approximately decreased during the final fourth part of the stroke thereof.

In general, the speed profile at which the die 7 moves to the punch 9 until the dose 10 is completely shaped is selected on the basis of the type of object to be moulded, of the geometry thereof, of the plastics used, of the viscosity and temperature thereof, of the temperature of the first forming arrangement and of the second forming arrangement. In this way it is possible to choose the most suitable speed for each particular application, which enables stress on the plastics to be reduced and objects, for example preforms 1, to be obtained that are of better quality.

In order to assess whether the stress acting on the plastics is acceptable, it is possible to use visual analysis techniques for analysing the moulded object, or simulate on the computer filling of the mould, or also use methods of another type.

When the preform 1 remains in the forming chamber 11 to be cooled, as shown by the third line L3 in the graph in FIG. 8, the die 7 is substantially stationary with respect to the punch 9.

By modifying the speed of the die 7 when the latter moves from the open position to the final position it is also possible to compensate for possible poor positioning of the dose in the cavity 8 of the die 7. It may in fact be, as shown in FIG. 9, that a dose 210, whilst it falls inside the cavity 8, is positioned obliquely, i.e. in such a way that the axis of the dose 210 is tilted with respect to that of the cavity 8. In this case the dose 210 is unable to slide until it reaches the bottom of the cavity 8 and remains positioned in an incorrect manner.

In order to remedy this situation, as shown by the first segment S1 of FIG. 12, the die 7 is moved at a constant and relatively high speed to the contact position shown in FIG. 10, in which an upper end of the dose 210 comes into contact with a lower end of the punch 9. At this point, as shown by the second segment S2 of FIG. 12, the speed of the die 7 is decreased significantly, or even the die 7 can be temporarily arrested, so as to enable the dose 210, pushed by the punch 9, to be correctly positioned and to reach the bottom of the cavity 8, as shown in FIG. 11. It is now possible to again increase the speed of the die 7, as shown by the third segment S3 of FIG. 12. In particular, in the instants represented by the third segment S3, the die 7 moves at a speed comprised between the speed corresponding to the first segment S1 and the speed corresponding to the second segment S2.

In this way compression-moulding the dose is avoided whilst the latter is positioned asymmetrically in the cavity 8, which could cause asymmetrical filling of the forming chamber 11 and consequently generate uneven stress in the plastics. In this case, a preform 1 would be obtained having uneven properties and aesthetic defects such as, for example, junction lines (so-called “weld lines”).

The die 7 can be moved as shown in FIG. 12 whenever doses 210 are processed having dimensions that are critical with respect to the cavity 8, i.e. doses for which a relatively high risk of incorrect positioning in the cavity 8 exists. It is possible to modify the speed of the die to overcome poor positioning of the dose even when objects, other than preforms, for example caps, are produced. In this latter case, the dose can sometimes be deposited on the bottom of the die in a decentralised position. If this occurs, by decreasing the speed of the die during the forming step it is possible to give the plastics the time to be repositioned correctly in the mould and to reduce the asymmetrical tensions that would otherwise be generated in the finished cap.

In an alternative embodiment, shown in FIG. 13, after the third segment S3 a fourth segment S4, having a lesser gradient than the third segment S3, can be provided. This means that, just before having completely shaped the dose 10, the die 7 is slowed further. In this way the stress applied to the plastics decreases in the last instants of forming, which are normally more critical than the initial instants.

Further, after maintaining the preform 1 inside the forming chamber 11 for a sufficient time, it is possible to move the die 7 slightly away from the punch 9 and then stop the die 7 for a short period P1, before definitively extracting the preform 1 from the mould 6. This makes extracting the preform 1 from the mould 6 more gentle. Instead of stopping the die 7 during the period P1, it is possible, at the start of the extraction step, to move the die 7 slowly with respect to the punch 9 and to increase the speed of the die 7 only at a later moment, i.e. when risks of damaging the preform 1 no longer exist.

Whilst the completely shaped preform 1 remains inside the forming chamber 11 to be cooled, pressure is applied to the plastics that is variable according to a preset profile, which may be of the type shown in FIGS. 14 to 17.

In particular, FIG. 14 shows how the pressure varies that is applied by the first forming arrangement and by the second forming arrangement to the plastics constituting the preform 1 in function of the time. In FIG. 14 two curves are visible that are indicated as pmax and pmin, corresponding respectively to the maximum pressure and minimum pressure profile that it is advisable to use to obtain a finished object of good quality.

It should be noted that whilst the die 7 approaches the dose 10 until the die 7 has shaped the dose 10 completely, which corresponds to the interval indicated by A on the x axis, the pressure of the plastics increases in quite a gradual manner until, in the final position shown in FIG. 6, it reaches maximum forming pressure, which is variable between p1 and p2. In general, maximum forming pressure corresponds to maximum closing force that is applied to the mould 6 and is sufficient to maintain it in the final position shown in FIG. 6. For example, it has been experimentally demonstrated that for a mould 6 of the type shown in FIGS. 3 to 6, p1 can be equal to 150 bar and p2 can be equal to 170 bar.

Whilst the preform 1, after being shaped, remains in the forming chamber 11, which corresponds to the interval indicated by B on the x axis, initially the pressure applied to the plastics remains constant and equal to maximum forming pressure. Subsequently, before completing the cooling phase in the mould of the preform 1, the pressure applied to the plastics decreases in a linear manner following a defined line having rather a limited gradient.

In order to reduce the pressure applied to the plastics, it is possible to decrease the pressure with which the die 7 is pushed to the punch 9, without nevertheless modifying the position of the die 7. In this way, the pressure applied to the plastics is varied in an isochoric manner, i.e. without substantially modifying the volume of the forming chamber 11.

When the preform 1 has cooled sufficiently, the pressure applied to the plastics is decreased rapidly to extract the preform 1 from the mould 6, as indicated by E in FIG. 14. It should be noted that the pressure applied to the plastics can be decreased not only by following the law indicated by pmax or pmin, but according to any other broken line comprised between pmax and pmin.

In all cases, by decreasing the pressure applied to the plastics it is possible to reduce the stress on the plastics, which are not overstressed and can relax, at least partially. The shape of the preform 1 can thus be stabilised rapidly inside the closed mould, which enables the preform 1 to be extracted much more quickly than is required by known methods.

In a first alternative embodiment, shown in FIG. 15, the pressure applied to the plastics constituting the preform 1 that are cooling in the forming chamber 11, after being maintained constant for a certain period, decreases progressively until zero is reached. The pressure applied to the plastics can decrease in a linear manner, as shown by the line indicated by pmin in FIG. 15, or can decrease in a linear manner to an intermediate value and then remain substantially constant for a certain period and finally decrease again in a linear manner, as shown by the line indicated by pmax. FIG. 16 shows a second alternative embodiment in which, whilst the preform 1 cools in the forming chamber 11, the pressure applied to the plastics is decreased following a “stepped” line. The embodiment shown in FIG. 16 derives from the one in FIG. 15 but decreases pressure more rapidly in order to reduce the duration of a moulding cycle.

In particular, pressure, after being maintained constant in the initial step in which the preform 1 is cooled in the forming chamber 11, is decreased in a first moment very rapidly, then more slowly, then fast again until the mould 6 is opened completely.

It is also possible to adopt the embodiment shown in FIG. 17, which is obtained by combining the embodiments of FIGS. 15 and 16.

In general, the pressure applied to the plastics can be modified, whilst the formed object is maintained in the forming chamber of the closed mould, according to a profile selected on the basis of numerous parameters, such as the type and geometry of the object to be moulded, the plastics used and the properties of the latter, in particular viscosity, temperature and thermal diffusivity, the cycle time, the temperature of the first forming arrangement and the second forming arrangement, the maximum settable pressure. The aforesaid pressure also depends on the energy that it is necessary to provide for the dose to transform the dose into the desired object. Given a dose having a preset weight and viscosity, a preform having a certain geometry and fixed process parameters listed previously, the energy to be supplied to the dose to transform it into the preform must be maintained substantially constant. Therefore, if the pressure applied to the plastics decreases, in order to maintain the energy constant, it is necessary to increase the time during which the pressure is applied. In other words, for the same dose and object to be obtained, the area under the curve that shows how the pressure applied to the plastics varies in function of time is approximately constant.

FIG. 18 shows a mould 106 that constitutes a version of the mould 6 shown in FIGS. 3 to 6. The parts of the mould 106 common to the mould 6 are indicated by the same reference numbers used for the mould 6 and are not disclosed again in detail.

The mould 106 comprises a die 107 that includes a tubular element 12, suitable for externally shaping the side wall 5 of the preform 1. Inside the tubular element 12 an internal element 18 is movable that is suitable for externally shaping the end wall 4 of the preform 1. A driving device that is not shown moves the internal element 18 parallel to an axis Z1 of the punch 9. The driving device may comprise, for example, an auxiliary actuator inside which a pressurised fluid, for example oil, is sent regardless of the main actuator that drives the tubular element 12.

In the closed position, the internal element 18 is pushed to the punch 9 inside the tubular element 12, in a manner to define, together with the tubular element 12, with the movable elements 20 and with the punch 9, a forming chamber 11 having a shape substantially corresponding to the shape of the preform 1 that it is desired to obtain.

During the moulding of the preform 1, the internal element 18 can be controlled in such a way as to make any of the pressure profiles shown in FIGS. 14 to 17, or a similar profile.

For this purpose, the pressure applied to the plastics can be decreased by reducing the pressure at which the internal element 18 is pushed to the punch 9, without substantially modifying the volume of the forming chamber 11. In order to do this, it is sufficient to reduce the pressure of the fluid that supplies the auxiliary actuator driving the internal element 18.

In an alternative embodiment, the pressure applied to the plastics can be decreased by increasing the volume of the forming chamber 11, whilst the mould 106 is still in the closed position. In order to do this, before the preform 1 has been cooled down to a temperature at which it can be removed from the forming chamber 11 without being damaged, i.e. when the mould 106 is still in the closed position, the internal element 18 is retracted, i.e. it is moved down, following a preset law, as shown schematically and in an enlarged manner with a line dotted in FIG. 18. The movement of the internal element 18 may be very small, for example of a few tenths of a millimetre, in such a way as not to cause visible changes to the geometry of the preform 1. For example, if it is desired to obtain a preform 1 comprising an end wall 4 having a thickness of 2 mm, it is possible to position the internal element 18 at the end of the forming step, at a distance of 1.8 mm from the punch 9. Whilst the preform 1 is cooled inside the mould 106, the internal element 18 is then retracted until it reaches a distance of 2 mm from the punch 9, so as to obtain a preform 1 of the desired thickness, owing to the “reverse flow back” disclosed previously.

If the internal element 18 is moved away from the punch 9 in the initial instants of cooling of the preform 1 in the closed mould, the tensions of the plastics decrease significantly. In fact, in this moment the plastics are still relatively fluid and hot, so the tension can relax very easily. In all cases, a certain decrease in tension also occurs if the internal element 18 is moved away from the punch 9 in the final instants of cooling of the preform 1 inside the closed mould.

It has been shown experimentally that by retracting the internal element 18, or however by decreasing the pressure applied to the plastics similarly to what is shown in FIGS. 14 to 17, it is possible to decrease the extracting force that has to be applied to the preform 1 to remove it from the mould 106. In particular, the extracting force may be equal to a tenth, or even less, of the extracting force that it would be necessary to apply if the pressure applied to the plastics were maintained constant during all the cooling of the preform in the mould. It is considered that the extracting force decreases because, owing to the relaxation of tension, the internal diameter of the preform 1 decreases little during cooling. Consequently, the preform 1 shrinks slightly onto the punch 9 and can be removed more easily from the latter. This enables the risk of damaging the preform 1 during the extraction step to be reduced.

Further, as the preform 1, in order to be removed from the mould 106, has to support an extracting force that is less than what is required in methods according to the prior art, it is possible to extract the preform 1 from the mould 106 even when the preform 1 is relatively hot, but without damaging the preform 1. This enables the time of the moulding cycle to be reduced compared with the time required by known methods.

It is possible to control the volume of the forming chamber 11 whilst the preform 1 is cooled and possibly to increase the volume of the forming chamber 11, so as to decrease the tension in the plastics, not only by moving or at least controlling the internal element 18 that shapes the end wall 4 of the preform 1, but also by moving or controlling any movable component of the mould that bounds a portion of the forming chamber.

In the examples disclosed above, reference has always been made to a mould in which the punch remains in a fixed position, whilst the die is moved between the open position and the final position. It is nevertheless possible to maintain the die fixed and to move the punch, or move both the die and the punch.

Further, the die and/or the punch can be moved not only by means of a hydraulic actuator, but also by a different driving arrangement, for example by a cam device or by an electric or electromechanical system.

Lastly, the moulds operating with the methods according to the invention can be used not only to produce preforms but also for compression-moulding objects other than preforms, such as, for example, caps for containers, washers, glasses, and containers of various type.

1-51. (canceled)

52. Method comprising the steps of:
depositing a dose of plastics, in a pasty state, in an open cavity of a mould;
compression-moulding said dose in a closed forming chamber defined inside said mould so as to obtain an object;
cooling said object in said closed forming chamber;
extracting said object from said closed forming chamber;
wherein during said cooling there is provided increasing volume of said closed forming chamber to decrease stress in said plastics.

53. Method according to claim 52, wherein said volume is increased after said forming chamber has been closed by mutually moving a first forming arrangement of said mould and a second forming arrangement of said mould towards each other.

54. Method according to claim 53, wherein said volume is increased by mutually displacing a first part and a second part of said first forming arrangement.

55. Method according to claim 54, wherein said first part comprises a movable part that externally shapes an end wall of said object.

56. Method according to claim 53, wherein said first forming arrangement shapes an external surface of said object and said second forming arrangement shapes an internal surface of said object.

57. Method according to claim 52, wherein said volume is increased before opening said closed forming chamber for extracting said object.

58. Method according to claim 52, wherein said volume is increased in an initial stage of said cooling.

59. Method according to claim 52, wherein said object is a preform from which a container can be formed by stretch-blow-moulding.

60. Method according to claim 53, wherein the step of mutually moving occurs at a speed that is variable according to a preset profile, said preset profile providing that said speed is diminished when said dose comes into contact with said second forming arrangement and starts to be shaped, in order to apply reduced stress to said plastics.

61. Method according to claim 60, wherein said speed is diminished when said first forming arrangement has a residual portion of stroke of at least 20% along which to travel.

62. Method according to claim 60, wherein, according to said preset profile, said speed is further diminished in an intermediate stage of the step of compression-moulding said dose, to enable said dose to be positioned in a substantially symmetrical manner in said cavity.

63. Method according to claim 62, wherein in said intermediate stage said speed assumes a zero value.

64. Method according to claim 60, wherein, according to said preset profile, said speed is decreased still further in a final stage of said step of compression-moulding.

65. Method according to claim 52, wherein, while said volume is increased, a pressure applied to said plastics is decreased according to a preset further profile for reducing the stress in said plastics.

66. Method according to claim 65, wherein, while said volume is increased, said pressure decreases in a linear manner.

67. Method according to claim 65, wherein said pressure is decreased in a stage comprising a first interval followed by a second interval, in said second interval said pressure decreasing more slowly than in said first interval.

68. Method according to claim 65, wherein said pressure is decreased in a stage comprising a first interval followed by a second interval, in said second interval said pressure decreasing more rapidly than in said first interval.

69. Method according to claim 65, wherein said pressure is decreased in a stage comprising an intermediate interval in which said pressure is maintained substantially constant.

70. Method according to claim 53, wherein, during said extracting, said first forming arrangement is moved away from said second forming arrangement according to a preset speed law.

71. Method according to claim 53, wherein said first forming arrangement comprises a die arrangement and said second forming arrangement comprises a punch arrangement.
